(19) United States
(12) Patent Application Publication
(10) Pub. No.: US 2022/0089920 A1
(43) Pub. Date: Mar. 24, 2022

(54) Anaerobically Curable Compositions

(71) Applicant: Henkel IP & Holding GmbH, Dusseldorf (DE)

(72) Inventors: Frances Murphy, Ratoath (IE); David Mullen, Co. Meath (IE); David Condron, Dublin (IE); Brendan Kneafsey, Lucan (IE); Nigel Sweeney, Terenure (IE)

(21) Appl. No.: 17/539,356

(22) Filed: Dec. 1, 2021

Related U.S. Application Data
(63) Continuation of application No. PCT/EP2020/066812, filed on Jun. 17, 2020.

(30) Foreign Application Priority Data
Jun. 21, 2019 (GB) 1908920.0

(51) Int. Cl. C09J 151/00; C09J 133/14; C09J 11/02; C08L 33/08

(52) U.S. Cl. CPC C09J 151/003; C09J 133/14; C09J 11/02; C08L 33/08; C09J 2475/00; C09J 2433/00; C09J 2451/00; C09J 2467/00; C09J 2400/163

(57) ABSTRACT

An anaerobically curable composition comprising:
(a) a non-encapsulated liquid anaerobically curable monomer forming a liquid phase;
(b) a solid component dispersed as a solid phase within the liquid phase formed by the non-encapsulated liquid anaerobically curable monomer;
wherein the solid component has (meth)acrylate functionality and:
   (i) is in particulate form with the particles having a particle size in the range from about 80 μm to about 300 μm; and
   (ii) has a melting temperature of from about 50° C. to about 90° C.; and
(c) a curing component for curing the anaerobically curable composition within the liquid phase.

The anaerobically curable composition can easily be coated onto substrates such as threaded fasteners or other parts in its flowable form and then converted to anaerobically curable composition in solid form.

### FIELD

The present invention relates to anaerobically curable compositions. In particular the present invention relates to anaerobically curable compositions that are easily dispensed, but remain in situ.

### BACKGROUND TO THE INVENTION

Anaerobically curable compositions generally are well known. See e.g. R. D. Rich, “Anaerobic Adhesives” in Handbook of Adhesive Technology, 29, 467-79, A. Pizzi and K. L. Mittal, eds., Marcel Dekker, Inc., New York (1994), and references cited therein. Their uses are legion and new applications continue to be developed.

Anaerobic adhesive systems are those which are stable in the presence of oxygen, but which polymerize in the absence of oxygen. Polymerization is initiated by the presence of free radicals, often generated from peroxy compounds. Anaerobic adhesive compositions are well known for their ability to remain in a liquid, unpolymerized state in the presence of oxygen and to cure to a solid state upon the exclusion of oxygen.

Often times anaerobic adhesive systems comprise resin monomers terminated with polymerizable acrylate ester such as methacrylate, ethylacrylate and chloroacrylate esters [e.g., polyethylene glycol dimethacrylate and urethane-acrylates (e.g., U.S. Pat. No. 3,425,988 (Gorman)] derived according to known urethane chemistry. Other ingredients typically present in anaerobically curable adhesive compositions include initiators, such as an organic hydroperoxide for example cumene hydroperoxide, tertiary butyl hydroperoxide and the like, accelerators to increase the rate at which the composition cures, and stabilizers such as quinone or hydroquinone, which are included to help prevent premature polymerization of the adhesive due to decomposition of peroxy compounds.

Desirable cure-inducing compositions to induce and accelerate anaerobic cure may include one or more of saccharin, toluidines, such as N,N-diethyl-p-toluidine (“DE-p-T”) and N,N-dimethyl-o-toluidine (“DM-o-T”), and acetyl phenyl hydrazine (“APH”) with maleic acid. See e.g. U.S. Pat. No. 3,218,305 (Krieble), 4,180,640 (Melody), 4,287,330 (Rich) and 4,321,349 (Rich).

Saccharin and APH are used as standard cure accelerator components in anaerobic adhesive cure systems. Indeed, many of the LOCTITE©-brand anaerobic adhesive products currently available from Henkel Corporation use either saccharin alone or both saccharin and APH.

Anaerobically curable adhesive compositions also commonly include chelators such as ethylenediamine tetraacetic acid (EDTA) which are employed to sequester metal ions.

For handling purposes it is desirable that anaerobically curable adhesive compositions are easily dispensed but remain in-situ once dispensed. One of the issues that arises is that for ease of dispensing it is desirable to have anaerobically curable adhesive compositions in liquid form. Liquids being flowable are amenable to dispensing. However if a composition is liquid and flowable it can be an issue to retain the composition on a substrate on which it is dispensed. Thus what is desirable for dispensing may become an issue afterwards for handling.

Even though the anaerobic curable composition may dry off somewhat, for example through evaporation (by being dried, or allowed to dry for a period), the material often remains wet and tacky. This leads to: potential contamination of anything that contacts the articles to which the material has been applied and also unwanted removal of the material which has been applied. The latter concern potentially compromises the integrity of any bond or seal later formed by the anaerobically curable composition because an insufficient amount may remain to form the desired bond or seal.

And of course where the liquid carrier material is itself the liquid monomer, it will remain in its liquid form until such time as it is anaerobically cured. So even though these compositions may be applied on a substrate, awaiting exposure to anaerobic conditions, they will remain wet or at least tacky until cured.

In the past additional components such as thickeners have been added to the material to make it less flowable but because other components are liquid the overall composition remains somewhat flowable and/or tacky.

Tape products have existed for example Loctite®249 Quicktape™. This product consists of a liquid anaerobic threadlocker, sandwiched between two films of non-reactive polyamide/polyurethane film.

Compositions, including those that are suitable for use in threadlocking applications may be applied in a dry to touch form but with later stage anaerobic cure functionality. To achieve this additional components are often used.

In some cases a dry to touch form is achieved using a cure mechanism. For example a first cure mechanism may form the dry to touch form so as to hold the composition in place on an article while a second (anaerobic) cure mechanism is activated later to achieve cure, for example to achieve threadlocking.

For example European Patent No. 0 077 659 (Thompson) describes a pre-applied polymerizable fluid for sealing and locking engineering parts. The composition has two mechanisms for curing and two curing reactions take place. The first mechanism is a UV light cure. An opacifier is dispersed in the fluid so that the fluid becomes substantially opaque to radiation. After the fluid is applied to the component it is exposed to UV radiation whereupon a coating is formed, creating a surface layer which is a dry, tack-free crust. The subcutaneous fluid is unaffected by the radiation (due to the opacifier) and remains in a generally liquid state. When the component is threaded into another the surface layer breaks and the second polymerisation (such as a free radical polymerization) is initiated and the second cure reaction takes place. The second polymerization mechanism acts to lock the threads together. In Thompson, only a skin is formed in the first polymerization and the remainder of the composition remains fluid below the skin. There is a risk therefore that during handling of the coated engineering parts the skin may be disrupted and the fluid composition may leak out.

European Patent No. 0 548 369 (Usami) describes a pre-applied adhesive composition for application to the threaded contact faces of a screw. The composition comprises a photo-hardening binder in which a secondary curable composition is dispersed. The secondary curable composition includes microencapsulated reactive monomer/activator/initiator.

International Patent Publication WO2004/024841 A2 (Haller) describes curable compositions for application to a threaded article. The composition comprises a dispersion of components of a first cure mechanism comprising: (a) a (meth)acrylate functional monomer component; (b) a (meth)acrylate functional oligomer component; and (c) a photoinitiator component; and (ii) components of a second cure mechanism comprising: (e) an amine component; and (f) an encapsulated epoxy resin component; together with (iii) a thickener component. The photoinitiator component is suitable upon irradiation of the composition to achieve a first cure through the depth of the composition applied to a threaded article so that a binder matrix is formed with the components of the second cure mechanism dispersed through the matrix.

An English language Abstract for Chinese patent publication CN102558490 seemingly discloses a hot-meltable prepolymer, which is a urethane or polyurethane (meth)acrylate prepolymer with (meth)acryloyl terminal groups. The melting point of the prepolymer is 50-80° C. An anaerobic adhesive is prepared from the hot-meltable prepolymer, monomer containing at least one acrylic ester group or methacryloyl group, promoter, stabilizer and initiator. Liquid monomers are combined with the prepolymer to form a gel.

International Patent Publication No. WO 2017/068196 to the present Applicant describes an anaerobically curable composition comprising an anaerobically curable component that is a combination of a solid resin component and a solid anaerobically curable monomer. A curing component for curing the anaerobically curable component is included. The composition is solid and has a melting point in the range from 30° C. to 100° C. The composition is dry to touch and can be used to form articles of manufacture such as a tape, an elongate filament, a gasket, a patch.

Notwithstanding the state of the art, it would be desirable to provide alternative anaerobically curable compositions that are suitable for typical end use applications including in threadlocking applications.

### SUMMARY

In one aspect, the present invention provides an anaerobically curable composition comprising:
(a) a non-encapsulated liquid anaerobically curable monomer forming a liquid phase;
(b) a solid component dispersed as a solid phase within the liquid phase formed by the non-encapsulated liquid anaerobically curable monomer;
   wherein the solid component has (meth)acrylate functionality and:
      (i) is in particulate form with the particles having an average particle size in the range from about 80 μm to about 300 μm; and
      (ii) has a melting temperature of from about 50° C. to about 90° C.; and
(c) a curing component for curing the anaerobically curable composition within the liquid phase.

The non-encapsulated liquid anaerobically curable monomer may be present in an amount from about 10% to about 50%, such as about 10% to about 40%, for example from about 10% to about 30%, by weight based on the total weight of the composition.

The solid component may be present in an amount from about 15% to about 50% such as from about 30% to about 45% by weight based on the total weight of the composition. The solid component is in particulate form when it is dispersed in the liquid phase.

The solid component is reactive—it participates in the anaerobic cure reaction.

The curing component/initiator is present in an amount from about 4% to about 6% by weight based on the total weight of the composition.

An anaerobically curable composition of the invention may further comprise from about 10% to about 30% propoxylated bisphenol A fumarate polyester by weight based on the total weight of the composition dissolved in the liquid phase. This component imparts a desirable viscosity when a composition of the invention is in paste form and also gives desirable physical properties to the solid form. Other viscosity modifiers such as acrylic resins (such as those available under the trade name Elvacite® from Lucite International) may be used. So too can silica. However it is desirable to use propoxylated bisphenol A fumarate polyester. Overall the amount of viscosity modifier (including propoxylated bisphenol A fumarate polyester) is typically from about 10% to about 30% by weight based on the total weight of the composition dissolved in the liquid phase.

The solid component desirably comprises solid anaerobically curable monomer with a melting point from about 50° C. to about 90° C.

Optionally the solid component comprises solid resin with a melting point from about 50° C. to about 90° C.

The solid resin has (meth)acrylate functionality.

In one form the composition of the invention is a flowable paste having a viscosity at 25° C. of from about 40,000 mPa·s to 500,000 mPa·s, such as from about 60,000 to about 180,000 mPa·s, for example from about 75,000 to about 125,000 mPa·s as measured by ASTM D4287.

An anaerobically curable composition of the invention may be provided in solid form formed by heating a composition according to any preceding claim so that the solid component melts to a melted form and mixes with the non-encapsulated liquid anaerobically curable monomer to form a mixture and passively or actively cooling the mixture to a solid form.

The invention also relates to a substrate having applied thereto an anaerobically curable composition of the invention in paste form.

The invention also relates to a substrate having applied thereto an anaerobically curable composition in solid form.

The invention also provides a method of formulating an anaerobically curable composition, the anaerobically curable composition comprising
(a) a non-encapsulated liquid anaerobically curable monomer forming a liquid phase;
(b) a solid component dispersed as a solid phase within the liquid phase formed by the non-encapsulated liquid anaerobically curable monomer;
   wherein the solid component has (meth)acrylate functionality and:
      (i) is in particulate form with the particles having an particle size in the range from about 80 μm to about 300 μm; and
      (ii) has a melting temperature of from about 50° C. to about 90° C.; and
(c) a curing component for curing the anaerobically curable composition within the liquid phase, the method comprising the step of dispersing the solid component in the liquid phase.

In a method of the invention it is desirable to add the curing component after the step of dispersing the solid component in the liquid phase.

Desirably the curing component is added in microencapsulated form.

The invention also provides a method for applying an anaerobically curable composition of the invention to a substrate comprising the steps of:
(a) formulating the composition as a flowable composition;
(b) applying the flowable composition to a substrate;
(c) heating the composition so that the solid component melts to a melted form and mixes with the non-encapsulated liquid anaerobically curable monomer to form a mixture; and
(d) passively or actively cooling the mixture to a solid form on the substrate.

The invention also relates to an assembly comprising a first substrate and a second substrate bonded together utilising any composition according to any of Claims 1 to 9.

A composition of the invention can be in two distinct forms.

At temperatures below the melting point of the solid component, for example temperatures less than 50° C., and thus at ambient temperatures, the composition is flowable forming a paste having a viscosity at 25° C. of from about 40,000 mPa·s to 500,000 mPa·s, such as from about 60,000 to about 180,000 mPa·s, for example from about 75,000 to about 125,000 mPa·s as measured by ASTM D4287. The solid component is solid and remains dispersed within the liquid phase. In this first paste form, formed by a solid dispersed within a liquid phase, the composition is anaerobically curable yet is flowable. At temperatures below the melting point of the solid component the solid component is insoluble in the liquid phase.

Once a composition of the invention is heated to, or above, the melting point of the solid component for example temperatures at or above 50° C., and thus well above ambient temperatures, the solid component melts to a liquid and moves into the liquid phase so there is now a combined single phase. In its melted form the solid component is miscible with the liquid phase. Once the combined materials cool below the melting point of the solid component, the composition does not return to a flowable paste form but instead becomes solid. For example it may be a waxy solid.

In this second form, the solid component and the non-encapsulated liquid anaerobically curable monomer are no longer in distinct phases, and instead are within a single solid phase. The composition remains uncured, but still anaerobically curable, yet is solid.

The solid component is compatible with and combines well with the liquid phase when the solid component is molten. It does not separate from the liquid phase.

When the composition is cooled the composition changes (from the paste form prior to heating) to solid form (to generate a homogenous solid form of the product).

The solid form can be a particulate form such as a powder form. The powder form is substantially dry so particles do not stick/clump together.

The solid component can be a combination of suitable materials.

The solid component is curable/reactive. The solid component participates in the anaerobic cure reaction and is itself anaerobically curable.

As such all reactive components, whether liquid or solid components of the composition, can participate in the anaerobic cure reaction.

In the present invention particle size is determined by laser diffraction in accordance with ASTM E2651-13.

Melting and re-solidification may be measured by DSC (Differential Scanning Calorimetry).

The invention disclosed herein relates to a novel anaerobically curable composition which has a novel physical form. It is an anaerobic adhesive composition which can be used to achieve dry-to-touch, solid coatings for pre-applied applications. The anaerobically curable composition contains curable solid reactive components (optionally with non-reactive components) which are suspended in liquid reactive monomers, combining to form a paste. At the melting point of the solids, the paste is converted to liquid as solids melt and then upon cooling it forms a solid material. It does not revert to paste form because of the mixing of the solid and liquid materials when the composition is heated and the solid material melts.

This new form of anaerobic product can be manufactured, handled and dispensed as a high viscosity liquid/paste, but is easily converted to a solid material by applying heat. It has been designed to address handling, processing and stability issues.

And of course it is flowable and anaerobically curable in its first form and is then solid but anaerobically curable in its solid form. Furthermore, the viscosity of its first form being 75,000 to 500,000 mPa·s at 25° C. (or indeed within the other viscosity ranges disclosed herein) means it can be dispensed in curable and flowable form onto a substrate. This allows versatility in application. Once on the substrate heating the composition can convert or set the composition into a solid form. The solid form is still anaerobically curable. The solid form has the advantage of being non-flowable so the anaerobically curable composition is retained on the substrate. The initial flowable composition can be converted into a solid composition and thus the flowable composition can be considered a plastisol.

For example the anaerobically curable composition can easily be coated onto substrates such as threaded fasteners or other parts in its flowable form and then converted to solid anaerobically curable composition. Once solid the risk of anaerobically curable composition causing handling issues because the material is flowable/liquid is eliminated. So equipment for handling the substrates, and other substrates which contact any coated substrates are less like to suffer contamination from the anaerobically curable composition transferring from physical contact with the equipment and/or other substrates.

The aim of the present inventors was to develop an anaerobically curable composition such as an anaerobic adhesive which could be applied onto substrates such as threaded fasteners with a quick dry-to-touch time, allowing fast turn-around of substrates in particular by eliminating drying times.

This is of interest for articles of manufacture such as substrates which are coated with anaerobically curable composition for later use. That is, they are coated with a composition of the invention so that they have pre-applied anaerobically curable composition in-situ for (later)—typically off-site use.

The market for pre-applied anaerobic products is currently served by water- and solvent-based products. These are applied using large footprint equipment in specialized coating centres. For example Henkel's Dri-Loc® products are a water based anaerobic adhesive technology. Some of these prior art compositions are two-part or three-part formulations that are mixed at the site of application and applied to large quantities of threaded fasteners on specialized equipment. The water (or solvent) content of the formulation is then removed using large drying ovens over several hours to deliver threaded bolts with pre-applied adhesive.

In the present invention an anaerobic adhesive is provided that contains solid elements which melt at reasonably low temperatures (for example 55-80° C.) and which can be applied to threaded parts in the molten form and will cool quickly to leave a solid coating on the parts. This eliminates the need for large scale drying ovens and specialized coating centres and, can provide a pre-applied solution, for example for smaller scale users.

A paste form at room temperature is straightforward for manufacturing and handling the composition including bottling/packaging.

Further the composition of the invention can also be in a solid form, for example within a container from which it is later taken for use rather than being pre-applied.

The paste form can be dispensed as a paste from a dispensing pack or cartridge pack.

As described herein the composition can be converted to a solid form in a pre-applied form, so that, an article of manufacture made at a first location for use at a second location can have the composition in solid form pre-applied on a substrate. Alternatively the conversion to solid form can occur at the site of dispensing/application to substrates.

One advantage of the present invention is that the composition is formulated as a one-part composition yet is still anaerobically curable. Storage stability has been achieved for at least 12 months when a composition of the invention is subjected to temperatures of 22° C. under ASTM: D1337. Some existing anaerobically curable compositions are formulated as an at least two-part composition because they are not storage stable/prematurely cure if formulated as a one-part composition.

Another advantage of the present invention is that the composition is fast to dry—there is no requirement for drying ovens or long drying times as with water-based or solvent-based compositions.

Compositions of the invention are thus well suited to smaller scale operations.

Compositions of the invention allow a unique combination of forms. For example a composition of the invention may be converted in sequence from a paste (with solid particles dispersed in a liquid phase) to a liquid (where the solid particles are melted to mix with the liquid phase) to a solid (the composition solidifies when cool).

The non-encapsulated liquid anaerobically curable monomer can be any liquid methacrylate; or acrylate; functionalised monomer. Any combination of non-encapsulated liquid anaerobically curable monomers can be used.

The solid component is curable/reactive. The solid component participates in the anaerobic cure reaction and is itself anaerobically curable.

Other components of the composition may however be liquid or solid and may be unreactive—they do not participate in the anaerobic cure reaction.

The solid component may be a solid form anaerobically curable monomer, for example 2-methacryloxyethylphenylurethane—“2-MAPU”.

The solid component may be a solid form methacrylate-functionalised resin, for example a long chain meth(acrylated) polyurethane with molecular weight >2000 g/mol.

The solid component may be any other solid, powdered material provided that overall it meets the parameters set out above.

Desirably, the solid component does not comprise polyethylene glycol, for example polyethylene glycol particles, which are inactive in the anaerobic cure reaction.

It will be appreciated that the solid component may be any combination of those materials listed above provided that overall it meets the parameters set out above.

Compositions of the invention have many end-use applications as with traditional anaerobically curable compositions.

Compositions of the present invention have applications in metal-metal bonding, such as threadlocking compositions, for securing, for example a female threaded article to a male threaded article, e.g. for securing nuts and bolts. The product cures when confined in the absence of air between close fitting (e.g. metal) surfaces. It protects threads from rust and corrosion and prevents loosening from shock and vibration.

The compositions of the invention are suitable for storage or handling e.g. shipping even when applied on a part. This storage or handling does not adversely affect the integrity of the composition for example when it is present as a coating.

Mating surfaces such as flanges e.g. in the automotive industry, in the past have been sealed by applying a liquid anaerobically curable composition onto the face of one of the surfaces. The two surfaces, for example flange faces, are then assembled and the product cures in the absence of oxygen thereby creating a gasket and a seal. A composition of the invention can be applied in either the liquid or paste form to such mating surfaces. For example it could be applied in paste form and then heated and converted to solid form.

Desirable cure-inducing components to induce and accelerate anaerobic cure may include one or more of saccharin, toluidines, such as N,N-diethyl-p-toluidine (“DE-p-T”) and N,N-dimethyl-o-toluidine (“DM-o-T”), and acetyl phenyl hydrazine (“APH”) with maleic acid. See e.g. U.S. Pat. No. 3,218,305 (Krieble), 4,180,640 (Melody), 4,287,330 (Rich) and 4,321,349 (Rich).

Stabilizers such as quinone or hydroquinone may be included.

The non-encapsulated liquid anaerobically curable monomer can be selected from any suitable anaerobically curable materials (or any combination of the materials) including those set out below. Desirably it is a liquid.

Anaerobic curable compositions may have an anaerobically curable component based on a suitable (meth)acrylate component.

One or more suitable (meth)acrylate components may be selected from among those that are a (meth)acrylate monomer having the formula: H₂C=CGCO₂R⁸,

where G may be hydrogen, halogen or alkyl groups having from 1 to about 4 carbon atoms, and R⁸ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, polyurethane, carbonate, amine, amide, sulfur, sulfonate, and sulfone.

One or more suitable (meth)acrylate monomers may be chosen from among polyfunctional (meth)acrylate monomers, such as, but not limited to, di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

For example the anaerobically curable component may include (as an anaerobically curable monomer) Bisphenol A dimethacrylate:

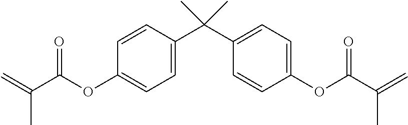 [SMILES: C=C(C)C(=O)Oc1ccc(C(C)(C)c2ccc(OC(=O)C(=C)C)cc2)cc1]

which has a melting point of approximately 72 to 74° C.

Still other (meth)acrylate monomers that may be suitable for use herein are silicone (meth)acrylate moieties (“SiMA”), such as those taught by and claimed in U.S. Pat. No. 5,605,999 (Chu), the disclosure of which is hereby expressly incorporated herein by reference.

Other suitable monomers may be chosen from polyacrylate esters represented by the formula

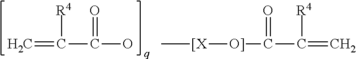

where R⁴ is a radical selected from hydrogen, halogen or alkyl of from 1 to about 4 carbon atoms; q is an integer equal to at least 1, and preferably equal to from 1 to about 4; and X is an organic radical containing at least two carbon atoms and having a total bonding capacity of q plus 1. With regard to the upper limit for the number of carbon atoms in X, workable monomers exist at essentially any value. As a practical matter, however, a general upper limit is about 50 carbon atoms, such as desirably about 30, and desirably about 20.

For example, X can be an organic radical of the formula:

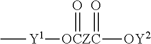

where each of Y¹ and Y² is an organic radical, such as a hydrocarbon group, containing at least 2 carbon atoms, and desirably from 2 to about 10 carbon atoms, and Z is an organic radical, preferably a hydrocarbon group, containing at least 1 carbon atom, and preferably from 2 to about 10 carbon atoms. Other monomers may be chosen from the reaction products of di- or tri-alkylolamines (e.g., ethanolamines or propanolamines) with acrylic acids, such as are disclosed in French Pat. No. 1,581,361.

Suitable oligomers with (meth)acrylate functionality may also be used. Examples of such (meth)acrylate-functionalized oligomers include those having the following general formula:

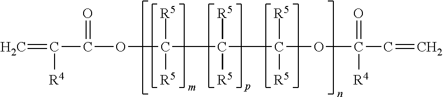

where R⁵ represents a radical selected from hydrogen, alkyl of from 1 to about 4 carbon atoms, hydroxy alkyl of from 1 to about 4 carbon atoms, or

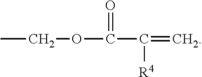

where R⁴ is a radical selected from hydrogen, halogen, or alkyl of from 1 to about 4 carbon atoms; R⁶ is a radical selected from hydrogen, hydroxyl, or

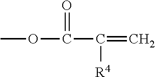

m is an integer equal to at least 1, e.g., from 1 to about 15 or higher, and desirably from 1 to about 8; n is an integer equal to at least 1, e.g., 1 to about 40 or more, and desirably between about 2 and about 10; and p is 0 or 1.

Typical examples of acrylic ester oligomers corresponding to the above general formula include di-, tri- and tetraethyleneglycol dimethacrylate; di(pentamethyleneglycol)dimethacrylate; tetraethyleneglycol diacrylate; tetraethyleneglycol di(chloroacrylate); diglycerol diacrylate; diglycerol tetramethacrylate; butyleneglycol dimethacrylate; neopentylglycol diacrylate; and trimethylolpropane triacrylate.

While di- and other polyacrylate esters, and particularly the polyacrylate esters described in the preceding paragraphs, can be desirable, monofunctional acrylate esters (esters containing one acrylate group) also may be used.

Suitable compounds can be chosen from among are cyclohexylmethacrylate, tetrahydrofurfuryl methacrylate, hydroxyethyl acrylate, hydroxypropyl methacrylate, t-butylaminoethyl methacrylate, cyanoethylacrylate, and chloroethyl methacrylate.

Another useful class of materials are the reaction product of (meth)acrylate-functionalized, hydroxyl- or amino-containing materials and polyisocyanate in suitable proportions so as to convert all of the isocyanate groups to urethane or ureido groups, respectively.

The so-formed (meth)acrylate urethane or urea esters may contain hydroxy or amino functional groups on the non-acrylate portion thereof. (Meth)acrylate esters suitable for use may be chosen from among those of the formula

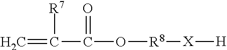

where X is selected from —O— and

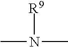

where R⁹ is selected from hydrogen or lower alkyl of 1 through 7 carbon atoms; R⁷ is selected from hydrogen, halogen (such as chlorine) or alkyl (such as methyl and ethyl radicals); and R⁸ is a divalent organic radical selected from alkylene of 1 through 8 carbon atoms, phenylene and naphthalene.

These groups upon proper reaction with a polyisocyanate, yield a monomer of the following general formula:

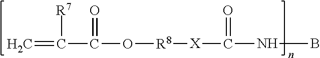

where n is an integer from 2 to about 6; B is a polyvalent organic radical selected from alkyl, alkenyl, cycloalkyl, cycloalkenyl, aryl, alkaryl, alkaryl and heterocyclic radicals both substituted and unsubstituted, and combinations thereof; and R⁷, R⁸ and X have the meanings given above.

Depending on the nature of B, these (meth)acrylate esters with urea or urethane linkages may have molecular weights placing them in the oligomer class (such as about 1,000 g/mol up to about 5,000 g/mol) or in the polymer class (such as about greater than 5,000 g/mol).

Of course, combinations of these (meth)acrylate monomers may also be used.

Desirably the anaerobically curable component comprises at least one acrylate or methacrylate ester group.

Desirably the anaerobically curable component comprises is chosen from at least one of epoxy (meth)acrylates, urethane (meth)acrylates, urethane di(meth)acrylates, alkyl (meth)acrylates, stearyl (meth)acrylates, isocyanurate (meth)acrylates, bisphenol-A-(meth)acrylates, ethoxylated bisphenol-A-(meth)acrylates, bisphenol-F-(meth)acrylates, ethoxylated bisphenol-F-(meth)acrylates, bisphenol-A di(meth)acrylates, ethoxylated bisphenol-A-di(meth)acrylates, bisphenol-F-di(meth)acrylates, and ethoxylated bisphenol-F-di(meth)acrylates.

The inventive compositions may also include other conventional components, such as free radical initiators, free radical accelerators, inhibitors of free radical generation, as well as metal catalysts, such as iron and copper.

A number of well-known initiators of free radical polymerization may be incorporated into the inventive compositions including, without limitation, hydroperoxides, such as CHP, para-menthane hydroperoxide, t-butyl hydroperoxide (“TBH”) and t-butyl perbenzoate. Other peroxides include benzoyl peroxide, dibenzoyl peroxide, 1,3-bis(t-butylperoxyisopropyl)benzene, diacetyl peroxide, butyl 4,4-bis(t-butylperoxy)valerate, p-chlorobenzoyl peroxide, cumene hydroperoxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane and combinations thereof.

Such peroxide compounds are typically employed in the present invention in the range of from about 0.1 to about 10 percent by weight, based on the total weight of the composition, with about 1 to about 5 percent by weight, based on the total weight of the composition, being desirable.

If desired the initiator component may be encapsulated. For example the initiator component may be an encapsulated peroxide, for example encapsulated benzoyl peroxide (“BPO”).

For example with a composition of the invention, encapsulated materials such as microencapsulated materials, for example the initiator component which may be an encapsulated peroxide, for example encapsulated benzoyl peroxide, can be dispersed in the first paste form without heat. This is advantageous as microencapsulated peroxide initiator BPO has a half-life of 1 hour at 92° C.

In the paste form microcaps and other powdered solids are easily dispersed; no settling, better stability.

Compositions of the present invention may further comprise thickeners and/or fillers.

As mentioned above it will be appreciated that the composition of the invention can include non-reactive species including resins. Such components do not participate in an anaerobic cure reaction. They are unreactive. Such components may however become part of the cure product having been incorporated therein during the curing of other components. Examples of such non-reactive species include: fumed silica, polyethylene, PTFE, mica, polyamide wax, titanium dioxide, barium sulphate.

### BRIEF DESCRIPTION OF THE DRAWINGS

Embodiments of the invention will be described, by way of example only, with reference to the accompanying drawings in which:

FIG. 1 is a graph showing 24 hour cure strengths of the composition of Example 2 on a variety of threaded fasteners.

### DETAILED DESCRIPTION

Embodiments of the invention will be described, by way of example only, with reference below:

### Example 1—Paste Formulation 4158-045

| | % wt (based on the total |
|---|---|
| Paste Formulation 4158-045 | weight of the composition) |
| Ethoxylated Bisphenol A Dimethacrylate | 22.6 |
| Saccharin | 0.4 |
| Acetyl phenylhydrazine | 0.4 |
| Butylated hydroxytoluene | 0.025 |
| Lauryl methacrylate | 10 |
| 2-Methacryloxyethylphenylurethane | 31.29 |
| LID 6882 Micronized | 31.29 |
| Microencapsulated BPO | 4 |

LID 6882 is a functional solid resin that is Di-functional Methacrylated PU resin from semi crystalline polyol. When it is micronized it has an average particle size of <100 μm.

The composition in the table above is combined with solid monomer: 2-Methacryloxyethylphenylurethane.

### Example 2: Paste Formulation 4158-063

| | % wt (based on the total |
|---|---|
| Paste formulation 4158-063 | weight of the composition) |
| Ethoxylated Bisphenol A Dimethacrylate | 23.175 |
| Butylated hydroxytoluene | 0.025 |
| Saccharin | 0.4 |
| Acetyl phenylhydrazine | 0.4 |
| ATLAC ® 382 Propoxylated Bisphenol- | 20 |
| A- Fumarate Polyester | |
| Poly(ethylene glycol) dimethacrylate | 12 |
| 2-Methacryloxyethylphenylurethane | 20 |
| LID 6882 Micronized | 20 |
| Microencapsulated BPO | 4 |

LID 6882 is a functional solid resin that is Di-functional Methacrylated PU resin from semi crystalline polyol. When it is micronized it has an average particle size of <100 μm.

The composition in the table above is combined with solid monomer: 2-Methacryloxyethylphenylurethane.

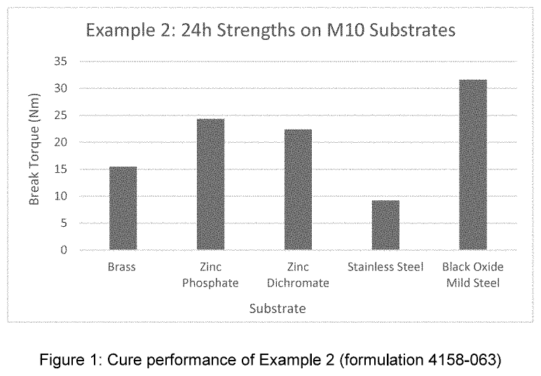

FIG. 1 is a graph showing 24 hour cure strengths of the composition of this example on a variety of M10 threaded fasteners. The composition of this example was applied onto M10 bolts that were heated to 90° C. The bolts used were made of stainless steel, zinc phosphate, zinc dichromate-coated steel, brass and black oxide-coated mild steel. The paste was applied to the heated parts where it melted and subsequently cooled to form a solid, wax-like coating. Mating nuts were combined with the coated parts and the unseated assemblies were allowed to cure for 24 hours, after which the strength required to break apart the assembled nuts and bolts was estimated on a torque-measuring device using ASTM D5649.

### Example 3: Paste Formulation 4158-064

| | % wt (based on the total |
|---|---|
| Paste Formulation 4158-064 | weight of the composition) |
| Ethoxylated Bisphenol A Dimethacrylate | 23.175 |
| Saccharin | 0.4 |
| Acetyl phenylhydrazine | 0.4 |
| ATLAC ® 382 Propoxylated Bisphenol- | 20 |
| A- Fumarate Polyester | |
| Poly(ethylene glycol) dimethacrylate | 12 |
| Butylated hydroxytoluene | 0.025 |
| 2-Methacryloxyethylphenylurethane | 20 |
| Polyethylene glycol Av. Mol. Wt | 20 |
| 8000 g/mol | |
| microencapsulated BPO | 4 |

With non-functional solid powder: polyethylene glycol with average molecular weight 8000 g/mol.

The composition in the table above is combined with solid monomer: 2-Methacryloxyethylphenylurethane.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. An anaerobically curable composition comprising:
(a) a non-encapsulated liquid anaerobically curable monomer forming a liquid phase;
(b) a solid component dispersed as a solid phase within the liquid phase formed by the non-encapsulated liquid anaerobically curable monomer;
wherein the solid component has (meth)acrylate functionality and:
(i) is in particulate form with the particles having an average particle size in the range from about 80 μm to about 300 μm; and
(ii) has a melting temperature of from about 50° C. to about 90° C.; and
(c) a curing component for curing the anaerobically curable composition within the liquid phase.

2. An anaerobically curable composition according to claim 1 wherein the non-encapsulated liquid anaerobically curable monomer is present in an amount from about 10% to about 50%, by weight based on the total weight of the composition.

3. An anaerobically curable composition according to claim 1 wherein the solid component is present in an amount from about 15% to about 50%, by weight based on the total weight of the composition.

4. An anaerobically curable composition according to claim 1 wherein the curing component is present in an amount from about 4% to about 6% by weight based on the total weight of the composition.

5. An anaerobically curable composition according to claim 1 further comprising from about 10% to about 30% propoxylated bisphenol A fumarate polyester by weight based on the total weight of the composition dissolved in the liquid phase.

6. An anaerobically curable composition according to claim 1 wherein the solid component comprises solid anaerobically curable monomer with a melting point from about 50° C. to about 90° C.

7. An anaerobically curable composition according to claim 1 wherein the solid component comprises solid resin with a melting point from about 50° C. to about 90° C.

8. An anaerobically curable composition according to claim 1 wherein the composition is a flowable paste having a viscosity at 25° C. of from about 40,000 mPa·s to 500,000 mPa·s, as measured by ASTM D4287.

9. An anaerobically curable composition in solid form formed by heating a composition according to claim 1 so that the solid component melts to a melted form and mixes with the non-encapsulated liquid anaerobically curable monomer to form a mixture and passively or actively cooling the mixture to a solid form.

10. A substrate having applied thereto an anaerobically curable composition according to claim 1.

11. A substrate having applied thereto an anaerobically curable composition according to claim 9.

12. A method of formulating an anaerobically curable composition, the anaerobically curable composition comprising
(a) a non-encapsulated liquid anaerobically curable monomer forming a liquid phase;
(b) a solid component dispersed as a solid phase within the liquid phase formed by the non-encapsulated liquid anaerobically curable monomer;
wherein the solid component has (meth)acrylate functionality and:
(i) is in particulate form with the particles having an particle size in the range from about 80 μm to about 300 μm; and
(ii) has a melting temperature of from about 50° C. to about 90° C.; and
(c) a curing component for curing the anaerobically curable composition within the liquid phase,
the method comprising the step of dispersing the solid component in the liquid phase.

13. A method according to claim 12 further comprising adding the curing component after the step of dispersing the solid component in the liquid phase.

14. A method according to claim 13 wherein the curing component is added in microencapsulated form.

15. A method for applying an anaerobically curable composition according to claim 1 to a substrate comprising the steps of:
(a) formulating the composition as a flowable composition;
(b) applying the flowable composition to a substrate;
(c) heating the composition so that the solid component melts to a melted form and mixes with the non-encapsulated liquid anaerobically curable monomer to form a mixture; and
(d) passively or actively cooling the mixture to a solid form on the substrate.

16. An assembly comprising a first substrate and a second substrate bonded together utilising a composition according to claim 1.
